(19) United States
(12) Patent Application Publication
(10) Pub. No.: US 2026/0074468 A1
(43) Pub. Date: Mar. 12, 2026

(54) Jump Starter Cable with Connector Including a Safety Pin

(71) Applicant: Vector Products, Inc., Boca Raton, FL (US)

(72) Inventors: Ling To Shum, Boca Raton, FL (US); Salvador Herrera, Boca Raton, FL (US)

(21) Appl. No.: 18/828,059

(22) Filed: Sep. 9, 2024

(51) Int. Cl. H01R 13/645; H02J 1/10

(52) U.S. Cl. CPC H01R 13/6456; H02J 1/122

(57) ABSTRACT

A jump starter cable includes: a pair of insulated wires with a first end and a second end opposite the first end; a pair of clamps residing at the first end; and a connector residing at the second end, the connector including: a first housing for a first pin; a second housing for a second pin; and a safety pin positioned proximate to the first housing and the second housing. In one aspect, the jump starter cable does not include a safety module. In another aspect, the connector is configured to couple to a port on a jump starter comprising an integrated safety module, where the port on the jump starter includes an opening corresponding to the safety pin.

### TECHNICAL FIELD

The present invention relates to portable jump starters in the automotive field, and more particularly to jump starter cables for coupling to portable jump starters.

### BACKGROUND ART

In the automotive market, jump starter cables may be used to couple a portable jump starter to a vehicle battery for the purpose of charging the vehicle battery. Clamps at one end of the jump starter cable attach the cable to the terminals of the vehicle battery. A standard connector, such as an EC5 connector, at the other end of the jump starter cable couple the cable to a compatible port on the portable jump starter. Some jump starter cables include a built-in safety module coupled between the clamps and the connector. The safety module includes components that provide safety features, such as reverse polarity protection, short circuit protection, and overload protection. Some portable jump starters incorporate a safety module that provides these safety features. The safety module in the cable or the portable jump starter would provide the safety features. However, a vehicle battery coupled to a portable jump starter without a safety module using a jump starter cable that is also without a safety module do not have the safety features, which may result in unsafe conditions.

### SUMMARY OF THE EMBODIMENTS

In accordance with one embodiment of the invention, a jump starter cable, includes: a pair of insulated wires with a first end and a second end opposite the first end; a pair of clamps residing at the first end; and a connector residing at the second end, the connector including: a first housing for a first pin; a second housing for a second pin; and a safety pin positioned proximate to the first housing and the second housing. In one aspect, the jump starter cable does not include a safety module. In another aspect, the connector is configured to couple to a port on a jump starter comprising an integrated safety module, where the port on the jump starter includes an opening corresponding to the safety pin.

### BRIEF DESCRIPTION OF THE DRAWINGS

The foregoing features of embodiments will be more readily understood by reference to the following detailed description, taken with reference to the accompanying drawings, in which:

FIG. 1 illustrates a jump starter cable with a connector including a safety pin.

FIGS. 2-5 illustrate a top perspective view, a front view, a top view, and a side view, respectively, of a close-up of the jump starter cable connector with the safety pin.

FIG. 6 illustrates a front perspective view of a portable smart jump starter with a port corresponding to the connector of FIGS. 2-5.

FIGS. 7-8 illustrate a perspective and front close-up views of the port of the portable smart jump starter.

### DETAILED DESCRIPTION OF SPECIFIC EMBODIMENTS

Embodiments of the present invention provide a jump starter cable with a connector that includes a safety pin. The jump starter cable does not include a safety module with components that provide safety features, such as reverse polarity protection, short circuit protection, and overload protection. The connector that includes the safety pin is configured to be compatible with a port on a smart jump starter that includes an integrated safety module. The port includes an opening corresponding to the safety pin on the connector. The safety pin prevents the connector from coupling to a port without the corresponding opening for the safety pin, which prevents the jump starter cable from coupling to a portable jump starter that may not include an integrated safety module.

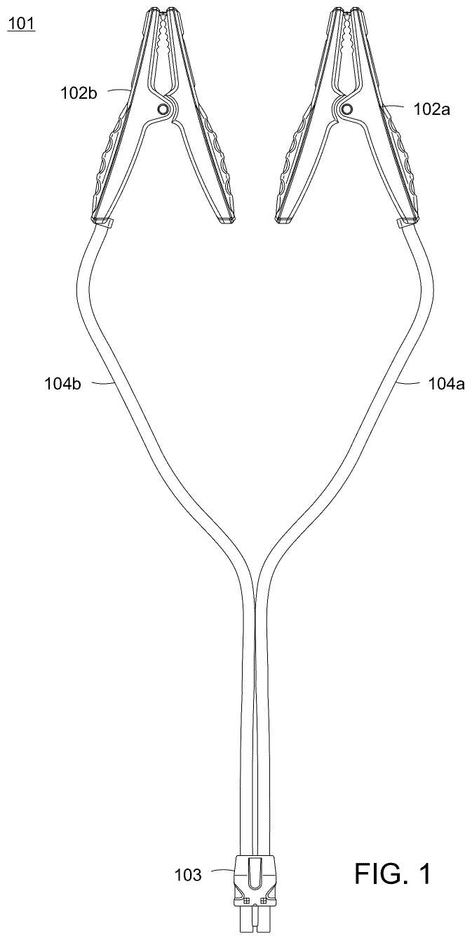

FIG. 1 illustrates a jump starter cable with a connector including a safety pin. The jump starter cable 101 includes a pair of insulated wires 104a-104b with a first end and a second end opposite the first end. A pair of clamps 102a-102b reside at the first end, with a first clamp 102a (conventionally colored red) for coupling to a positive terminal of a battery and a second clamp 102b (conventionally colored black) for coupling to a negative terminal of the battery. A connector 103 reside at the second end. The jump starter cable 101 does not include a built-in safety module with components that would otherwise provide safety features, such as reverse polarity protection, short circuit protection, and overload protection.

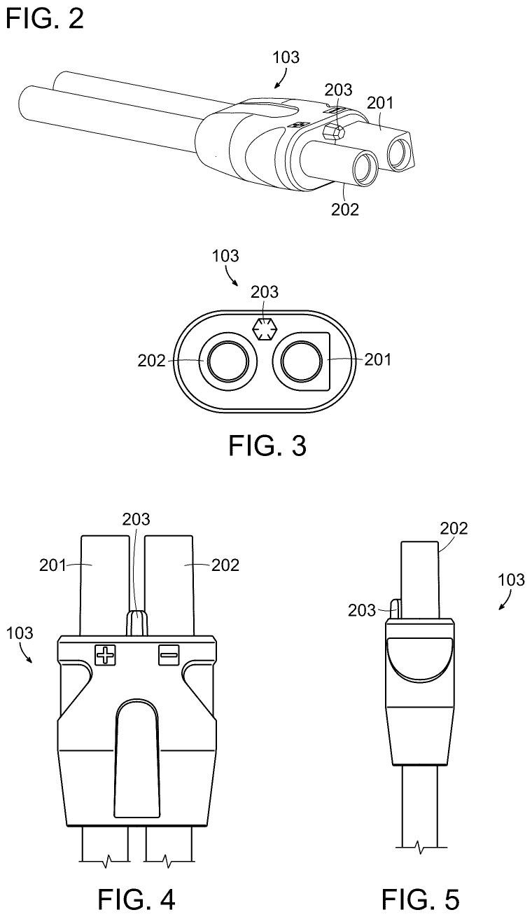

FIGS. 2-5 illustrate a top perspective view, a front view, a top view, and a side view, respectively, of a close-up of the jump starter cable connector 103 with the safety pin 203. A first housing 201 for a first pin (not visible) and a second housing 202 for a second pin (not visible) reside at the front of the connector 103. The first housing 201 and second housing 202 are configured as an EC5 connector. An EC5 connector is a 5 mm connector used to connect batteries for charging by a power supply. According to the EC5 standard, the squared first housing 201 corresponds to the first clamp 102a, where the first clamp 102a may be electrically coupled to a first female bullet pin (not visible) within the first housing 201 via the insulated wire 104a. The round second housing 202 corresponds to the second clamp 102b, where the second clamp 102b may be electrically coupled to a second female bullet pin (not visible) within the second housing 202 via the insulated wire 104b. The first and second housing 201, 202 are of equal length.

In addition to the first and second housing 201, 202 based on the EC5 standard, the connector 103 includes a safety pin 203 proximate to the first and second housing 201, 202. In the illustrated embodiment, the safety pin 203 is positioned equidistant from the first and second housing 201, 202 and is shorter than the first and second housing 201, 202. The safety pin 203 is further positioned proximate to the top side of the connector 103 and distal from the bottom side of the connector 103. The safety pin 203 may be positioned elsewhere on the front of the connector 103, as long as the safety pin 203 does not interfere with the functioning of the first and second housing 201, 202. For example, the safety pin 203 may be positioned proximate to the bottom side of the connector 103 and distal from the top side of the connector 103. For another example, the safety pin 203 may be positioned closer to the first housing 201 than the second housing 202, or vice versa. The safety pin 203 may also be the same or longer in length than the first and second housing 201, 202. The first and second housing 201, 202 are configured to couple to corresponding receptacles on a portable smart jump starter with an integrated safety module, as described further below.

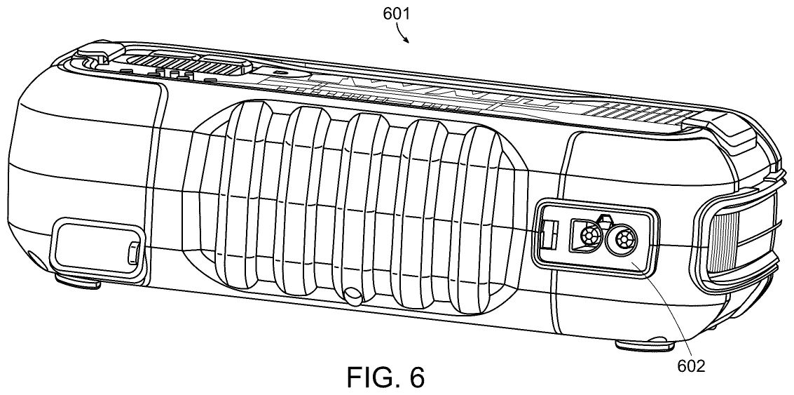

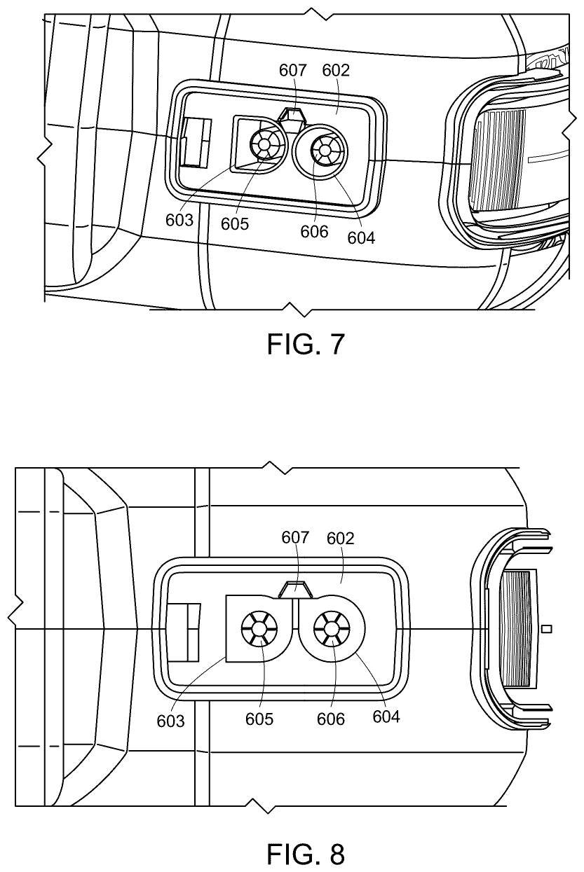

FIG. 6 illustrates a front perspective view of the portable smart jump starter 601 with a port 602 corresponding to the connector 103. FIGS. 7-8 illustrate a perspective and front close-up views of the port 602 of the portable smart jump starter 601. The portable smart jump starter 601 includes an integrated safety module (not visible) with components that provide safety features, such as reverse polarity protection, short circuit protection, and overload protection. The port 602 includes a first receptacle 603 and a second receptacle 604. Within the first receptacle 603 resides a first pin 605, and within the second receptacle 604 resides a second pin 606. The first and second receptacles 603, 604 are configured to couple to a standard EC5 connector. The first pin 605 includes a first male bullet pin, and the second pin 606 includes a second male bullet pin. The port 602 further includes an opening 607.

When the connector 103 is fully engaged with the port 602, the first female bullet pin within the first housing 201 of the connector 103 is electrically coupled to the first male bullet pin 605 within the first receptacle 603, and the second female bullet pin within the second housing 202 of the connector 103 is electrically coupled to the second male bullet pin 606 within the second receptacle 604. The opening 607 is positioned to correspond to the position of the safety pin 203 on the connector 103. The size and depth of the opening 607 are configured to correspond to the size and length of the safety pin 203. When the connector 103 is fully engaged with the port 602, and the safety pin 203 of the connector 103 securely resides within the opening 607. The safety pin 203 prevents the connector 103 from coupling to a port that does not include an opening for the safety pin 203.

In one example implementation, the opening 607 may be provided on portable jump starters with integrated safety modules. The cable 101 with the connector 103 including the safety pin 203 is able to connect to these portable jump starters, with the integrated safety modules of the portable jump starters providing the safety features. However, the cable 101 is prevented from coupling to a jump starter without the opening 607. Such jump starter may not include an integrated safety module. By preventing the coupling of the cable 101 to such a jump starter, potentially unsafe conditions may be avoided.

The port 602 of the portable smart jump starter is configured to be able to couple to both a standard EC5 connector without a safety pin and the connector 101 with the safety pin 203. The port 602 may couple to a cable that includes a built-in safety module and a standard EC5 connector without the safety pin. The port 602 may also couple to a cable that does not include a built-in safety module and has a standard EC5 connector without the safety pin. As set forth above, the port 602 may further couple to the cable 101 that does not include a build-in safety module and has the connector 103 with the safety pin 203. In each of these situations, safety features are provided by the integrated safety module of the jump starter 601.

Reference in this specification to “one embodiment”, “an embodiment”, “an exemplary embodiment”, “some embodiments”, or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

All components of the device and their locations, electronic communication methods between the system components, magnet types, cables, wiring, attachment or securement mechanisms, mechanical connections, electrical connections, dimensions, values, materials, charging methods, battery types, applications/uses, tools and devices that can be used therewith, etc. discussed above or shown in the drawing, if any, are merely by way of example and are not considered limiting and other component(s) and their locations, electronic communication methods, magnet types, cables, wiring, attachment or securement mechanisms, mechanical connections, electrical connections, dimensions, values, materials, charging methods, battery types, applications/uses, tools and devices that can be used therewith, etc. can be chosen and used and all are considered within the scope of the disclosure.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P”so as to avoid confusion with the actual claims presented below) includes:
P1. A jump starter cable, comprising: a pair of insulated wires with a first end and a second end opposite the first end; a pair of clamps residing at the first end; and a connector residing at the second end, the connector comprising: a first housing for a first pin; a second housing for a second pin; and a safety pin positioned proximate to the first housing and the second housing.
P2. The jump starter cable of P1, wherein the jump starter cable does not include a built-in safety module.
P3. The jump starter cable of P1, wherein the first housing and the second housing are configured according to an EC5 standard.
P4. The jump starter cable of P1, wherein the safety pin is positioned to be equidistant from the first housing and the second housing.
P5. The jump starter cable of P4, wherein the safety pin is further positioned proximate to a top side of the connector and distal from a bottom side of the connector.
P6. The jump starter cable of P1, wherein the connector is configured to couple to a port on a jump starter comprising an integrated safety module.
P7. The jump starter cable of P6, wherein the port on the jump starter comprises an opening corresponding to the safety pin.
P8. A jump starter cable, comprising: a pair of insulated wires with a first end and a second end opposite the first end; a pair of clamps residing at the first end; and a connector residing at the second end, the connector comprising: a first housing for a first pin; a second housing for a second pin; and a safety pin positioned proximate to the first housing and the second housing, wherein the jump starter cable does not include a safety module.
P9. The jump starter cable of P8, wherein the connector is configured to couple to a port on a jump starter comprising an integrated safety module.
P10. The jump starter cable of P6, wherein the port on the jump starter comprises an opening corresponding to the safety pin.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A jump starter cable, comprising:
a pair of insulated wires with a first end and a second end opposite the first end;
a pair of clamps residing at the first end; and
a connector residing at the second end, the connector comprising:
a first housing for a first pin;
a second housing for a second pin; and
a safety pin positioned proximate to the first housing and the second housing.

2. The jump starter cable of claim 1, wherein the jump starter cable does not include a built-in safety module.

3. The jump starter cable of claim 1, wherein the first housing and the second housing are configured according to an EC5 standard.

4. The jump starter cable of claim 1, wherein the safety pin is positioned to be equidistant from the first housing and the second housing.

5. The jump starter cable of claim 4, wherein the safety pin is further positioned proximate to a top side of the connector and distal from a bottom side of the connector.

6. The jump starter cable of claim 1, wherein the connector is configured to couple to a port on a jump starter comprising an integrated safety module.

7. The jump starter cable of claim 6, wherein the port on the jump starter comprises an opening corresponding to the safety pin.

8. A jump starter cable, comprising:
a pair of insulated wires with a first end and a second end opposite the first end;
a pair of clamps residing at the first end; and
a connector residing at the second end, the connector comprising:
a first housing for a first pin;
a second housing for a second pin; and
a safety pin positioned proximate to the first housing and the second housing,
wherein the jump starter cable does not include a safety module.

9. The jump starter cable of claim 8, wherein the connector is configured to couple to a port on a jump starter comprising an integrated safety module.

10. The jump starter cable of claim 6, wherein the port on the jump starter comprises an opening corresponding to the safety pin.
